(19) United States
(12) Patent Application Publication
(10) Pub. No.: US 2002/0185513 A1
(43) Pub. Date: Dec. 12, 2002

(54) Bag separator and dispenser

(76) Inventor: Joseph W. Morris, Hartsville, SC (US)

Correspondence Address: MICHAEL A MANN, NEXSEN PRUET JACOBS & POLLARD LLC, PO DRAWER 2426, COLUMBIA, SC, 29202-2426, US

(21) Appl. No.: 09/878,837

(22) Filed: Jun. 11, 2001

(51) Int. Cl. B26F 3/02

(52) U.S. Cl. 225/96; 225/94

(57) ABSTRACT

A bag dispenser, for separating and dispensing plastic bags where the bottom of one bag is attached to the top of the next bag by perforation lines with a hole therebetween. Preferably the bags are composed of 10% low density polyethylene and 90% high density polyethylene. The dispenser comprises a frame that holds a shaft on which a roll of the bags is placed and includes a shelf below the roll of bags. The shelf has a bag stop on the end of it that intercepts the holes between the bags and causes them to separate along the perforation lines. The shelf is attached by brackets secured with bolts and wing nuts to the frame of existing bag dispensers to backfit those dispensers with the present device.

### 1. FIELD OF THE INVENTION

The present invention relates generally to devices for dispensing a series of articles and more specifically relates to plastic bag dispensers where each bag is separated from a roll of bags.

### 2. BACKGROUND

In supermarkets and other types of food markets, fruits, vegetables, and other produce are displayed in bulk, on tables or in open coolers along the walls. Plastic bags are provided for consumers who want to bag their produce selections. The most common way to dispense these produce bags is on cylindrical rolls mounted horizontally or vertically The top of each bag is attached to the bottom of the next bag. Each bag may be separated from the next along a perforated line that defines the end of one bag and the start of the next bag. By grabbing a bag with one hand and the next bag with the other hand, and then pulling, the consumer can separate the two bags along the perforation line. Sometimes consumers will tear or stretch the bags when trying to separate them or attempt to simply jerk the bag from the roll causing it to unravel. Additionally, after a bag has been taken from the roll, the next bag may lie flat on the surface of the roll, making it very difficult to find or peel from the roll. Ultimately, however, removing bags from a roll of bags is a two-handed task.

Simhaee, in U.S. Pat. Nos. 5,261,585, 5,219,424, and 5,135,146, discloses plastic bag dispensers that enable the consumer to tear the bags with one hand without the bags unraveling by pulling the bags across a single finger This improvement facilitates the separation of the bags; however, there is still a need for further improvement. These bag dispensers must be carefully mounted to surfaces so that they are properly oriented for dispensing bags.

U.S. Pat. No. 5,556,019, issued to the present inventor, describes a dispenser that separates a bag as each one is pulled from a roll of bags over a spring finger. However, this bag separator requires a different type of mounting bracket than is currently being used in many supermarkets. Thus, there remains a need to provide a bag dispenser that works well and can be easily incorporated into the existing dispenser systems of supermarkets.

### SUMMARY OF THE INVENTION

According to its major aspects and briefly described, the present invention is a plastic bag dispenser. The bag dispenser holds a series of bags where one bag is connected at its bottom end to the top of the next bag, but where a line of perforations and a slot or hole facilitates separation of the bags. Preferably, the bottom of one bag is connected to the handles of the next bag, and, where connected, perforations permit and guide the separation of adjacent bags. Additionally, the series of bags is rolled onto a core, so that they may be supported and dispensed as the bags are unrolled.

The bag dispenser, in one embodiment, comprises a support frame, a shaft held to the support frame holding a roll of bags, and a shelf with integral bag stop. Because current bag dispensers have a support frame and shaft, the invention also comprises a shelf with integral bag stop for use with a support frame and shaft. Finally, the present invention comprises a method for separating bags from a roll of bags.

The support frame mounts to any surface and includes two arms for holding the shaft, one arm holding in so that it does not rotate with the core and the other merely supporting it. The shelf fastens to the frame and holds the next bag in the ready position. As the user pulls on the bag at the end of the roll of bags, the roll unwinds and slides over the integral bag stop, until the hole or slit slips over the bag stop. The stop holds the next bag until the previous one separates from it.

The shelf with integral bag stop is an important feature of the present invention. This shelf can be backfitted to existing dispensers that are widely used in many grocery stores. At relatively low cost, then, these existing dispensers can be modified so that the dispensing of bags to consumers is one-handed task.

The shape of the shelf is another important feature of the present invention. The shape causes the bag to drape in the ready-to-pull position so that the user can grasp it easily and does not have to “find” the end of the bag. Moreover, the user can pull on the end of the bag from either side and the bag catcher will still separate the selected bag from the next bag.

An important feature of the alternative embodiment of the present invention is the notches in the shelf. As the bag is dispensed, the notches help guide the bag and grips the next bag in line to that the current bag can be easily torn. Additionally notches provide stability for the user as the bag is torn so that the tear is even.

Other features and advantages of the present invention will be apparent to those skilled in the art from a careful reading of the Detailed Description Of A Preferred Embodiment accompanied by the following drawings.

### BRIEF DESCRIPTION OF THE DRAWINGS

In the drawings,

FIG. 1 is a perspective view of the bag dispenser according to the preferred embodiment of the present invention with a bag resting on the support shelf;

FIG. 2 is a cross sectional view of the bag dispenser taken along lines 2-2 of FIG. 4, according to the preferred embodiment of the present invention with a bag resting on the support shelf;

FIG. 3 is a top view of the bag dispenser with a roll of bags according to the preferred embodiment of the present invention;

FIG. 4 is a front view of the bag dispenser with a roll of bags according to the preferred embodiment of the present invention;

FIG. 5 is a perspective of the the bag dispenswer with a roll of bags according to a first alternative embodiment of the present invention;

FIG. 6 is a top view of the bag dispenser with a roll of bags according to a first alternative embodiment of the present invention;

FIG. 7 is a perspective of the the bag dispenswer with a roll of bags according to a second alternative embodiment of the present invention; and

FIG. 8 is a top view of the bag dispenser with a roll of bags according to a second alternative embodiment of the present invention.

### DETAILED DESCRIPTION OF PREFERRED EMBODIMENTS

In the following description similar components are referred to by the same reference numeral in order to simplify the understanding of the sequential aspect of the drawings.

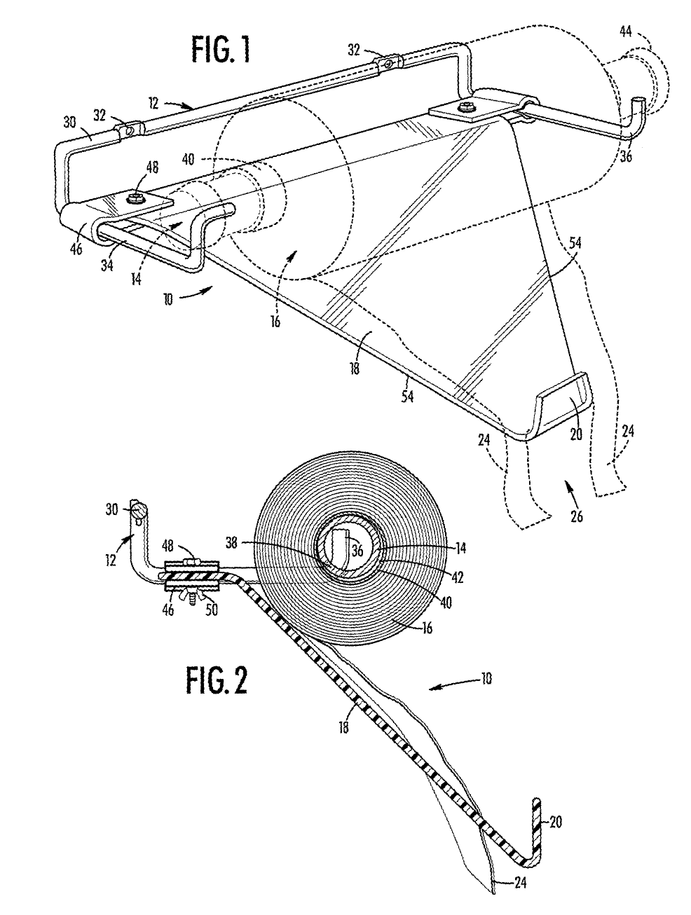

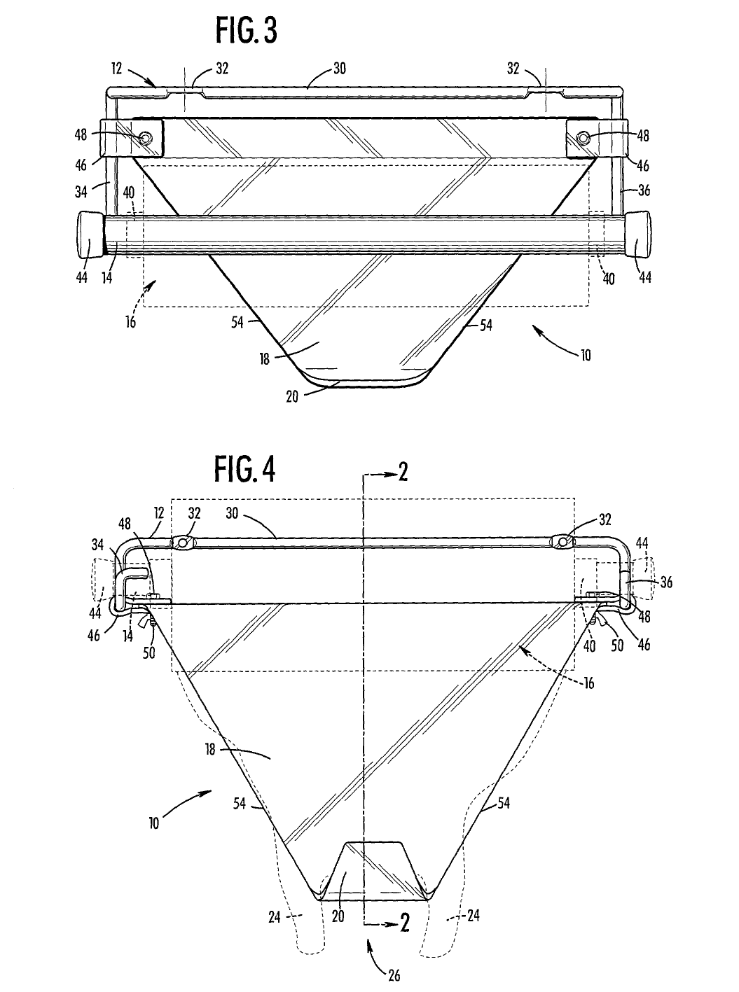

Now referring to FIGS. 1, 2, 3, and 4, a bag dispenser 10 in its preferred embodiments as a dispenser that includes the support frame and shaft, that is for use with a pre-existing support frame and shaft, and that is a method for separating bags from a roll of bags. The term “bags” means of course plastic bags as are commonly used in grocery stores for produce. These bags may have handles integrally formed as part of the bag. A roll of bags is a series of bags wound onto a hollow plastic or paper core where the bottom of each bag is attached to the top of the next bag. At the point of attachment, there is a line of perforations in the bag material to facilitate separation of the bags and a much larger hole in that line of perforations. Here in particular, the top of a bag may include its handles. Preferably the present dispenser works best with polyethylene bags that are about 10% low density polyethylene and 90% high density polyethylene for a crisper tear along the perforations.

In its full embodiment, a dispenser 10 comprises a support frame 12 that holds a shaft 14 on which is positioned a roll 16 of bags. Frame 12 holds shaft 14 above a tapered shelf 18 having a bag stop 20. Bags 22 from roll 16 drape onto shelf 18 so that handles 24 straddle bag stop 20 and the hole 26 between handles 24 is between them.

Support frame 12 includes a mounting bar 30 having a pair of holes 32 for use in attaching bar 30 to a surface such as a wall or counter (not shown). Frame 12 has a first arm 34 and an opposing second arm 36 that hold shaft 14 in place. To prevent shaft 14 from rotating, two holes 38 are formed in shaft 14 that receive first and second arms 34, 36. The end of first arm 34 is curved so that, once inside shaft 14, it is coaxial with shaft 14. The end of second arm 36 is not curved; therefore, once inside shaft 14, it remains perpendicular to the axis of shaft 14.

Roll 16 comprises bags 22 wound onto a core 40 made of plastic or cardboard. Core 40 has an interior diameter that is slightly larger than exterior diameter of shaft 14 leaving a small gap 42 so that roll 16 rotates freely on core 40. End caps 46 can be used to finish the appearance of the end of shaft 16.

Shelf 18 includes a pair of brackets 46 that are secured to first arm 34 and second arm 36 of frame 12 using bolts 48 and wing nuts 50. Brackets 46 hold shelf 18 so that it is under shaft 14 and extends away from the wall or counter to which mounting bar 30 is attached. Shelf 18 has tapered sides 54 that lead to bag stop 20. The outer edges of bags drap down so that users can grasp them readily and pull them over bag stop 20 until hole 26 of the next bag is reached. Then bag stop 20 enters hole 26 and prevents further movement of the next bag 22. Because user continues to pull on the bag 22 in hand, the tension between bags 22 results in the tearing along the perforations between bags, thus separating the bags.

In use, shaft 14 is lifted off second arm 36 and slid lengthwise from first arm 34 to free it from frame 12, which has been secured to a wall or counter. Roll 16 is slid onto shaft 14 which is then replaced on frame 12.

When a user wishes to obtain a bag 22 from roll 16, he grasps the end of bag 22 by one of its handles 24 and pulls bag 22 over shelf 18 and bag stop 20 on the end of shelf 18. When bag 22 passes over bag stop 20 and bag stop 20 enters the hole 26 between handles 24, bag stop 24 prevents the next bag 22 from being pulled. The tension between bag 22 and the next bag 22 caused by the user pulling bag 22 while bag stop 20 prevents the next bag 22 from moving causes the bags to separate along the perforations between them.

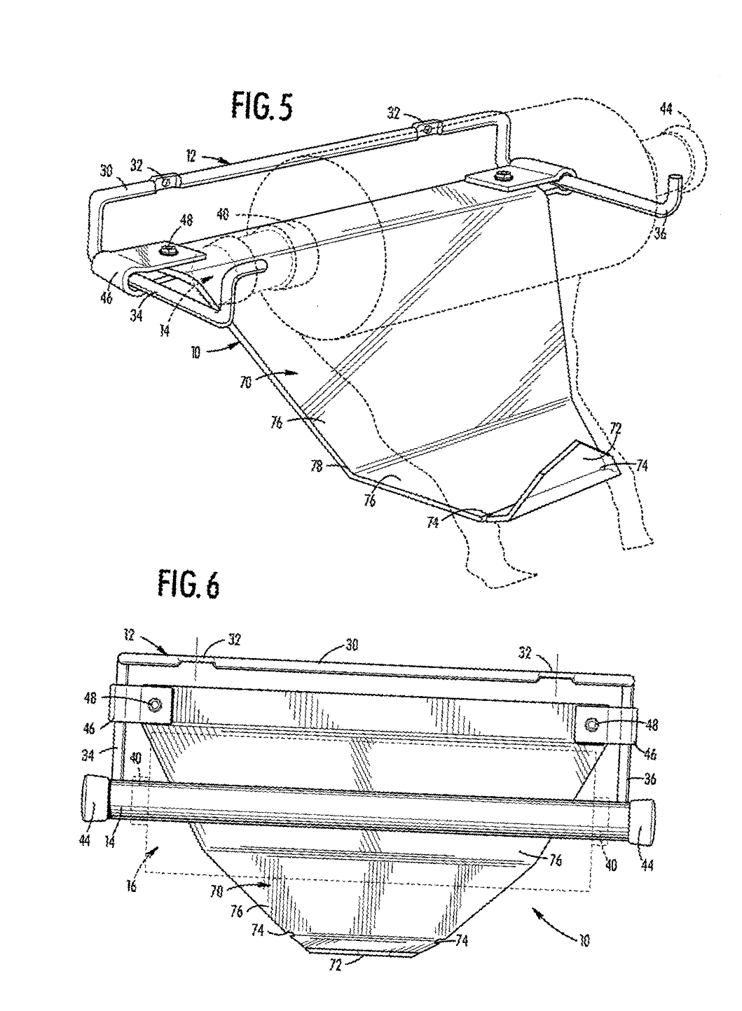

In a first alternative embodiment illustrated in FIGS. 5 and 6, only shelf 70 and bag stop 72 are modified; consequently, only the changes to shelf 70 and bag stop 72 will be described. Shelf 70 has tapered sides 78 that lead to bag stop 72. A plurality of panels 76 are integrally formed in shelf to provide easy guidance of bags. Preferably two panels 76 having an angle between panels about 135° is used, the angle could be between around 90° to around 180°. A pair of notches 74 is formed in shelf 70 to grip bags as the user pulls. The outer edges of bags drap down so that users can grasp them readily and pull them over bag stop 72 until hole 26 of the next bag is reached. Bag stop 72 is preferably tapered to a point in order to provide guidance for the bag. Then bag stop 72 enters hole 26 and in conjunction with notches 74 prevents further movement of the next bag 22. Because user continues to pull on the bag 22 in hand, the tension between bags 22 results in the tearing along the perforations between bags, thus separating the bags.

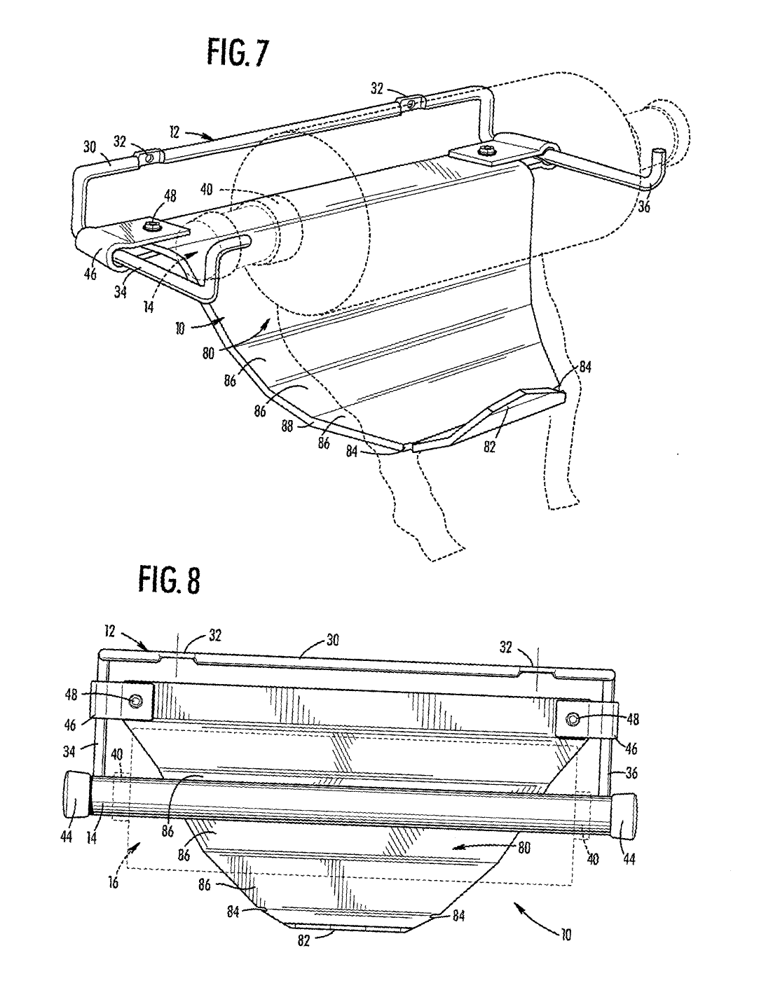

In a second alternative embodiment illustrated in FIGS. 7 and 8, only shelf 80 and bag stop 82 are modified; consequently, only the changes to shelf 80 and bag stop 82 will be described. Shelf 80 has tapered sides 88 that lead to bag stop 82. A plurality of panels 86 are integrally formed in shelf to provide easy guidance of bags. The obtuse angles between panels causes shelf to be slightly curved as illustrated in FIG. 7. Instead of a plurality of panels, shelf could be formed to have the curved surface resulting from panels. A pair of notches 84 is formed in shelf 80 to grip bags as the user pulls. Notches 84 grip next bag 22 to provide a balanced tension across the entire line of perforations between bags. A balanced tension provides an approximately equal amount of tension to perforations on each side of bag stop 82. The outer edges of bags drap down so that users can grasp them readily and pull them over bag stop 82 until hole 26 of the next bag is reached. Then bag stop 82 enters hole 26 and in conjunction with notches 84 prevents further movement of the next bag 22. Because user continues to pull on the bag 22 in hand, the tension between bags 22 results in the tearing along the perforations between bags, thus separating the bags.

In a grocery store or other place where conventional bag dispensers are in use, a bag dispenser of the present invention can be established by simply attaching shelf 18 to the existing frame 12 of the prior art dispenser by brackets 46 and securing brackets 46 with bolts 48 and wing nuts.

Frame 12 is preferably made of steel or rigid plastic; shelf 18 may be made of plastic, preferably clear plastic, but metal shelves 18 will suffice. Shaft 16 may be made of plastic, metal or cardboard. Bag stop 20 is preferably integral and is an extension of shelf 18 that curves back on itself just enough to intercept hole 26 between handles 24 of bag 22.

Bags 22 are preferably of the type having handles 24 but alternatively, wide slits will also work.

It will be apparent to those skilled in the art that many modifications and substitutions can be made to the foregoing preferred embodiment without departing from the spirit and scope of the present invention, which is defined by the appended claims.

What is claimed is:

1. A device for use with a frame formed to hold a roll of bags in a generally horizontal position and freely rotatable about a generally horizontal axis, said roll of bags comprising a series of bags connected together, said each bag of said series of bags connected to a next bag in said series of bags and separable along a line of perforations including a much larger hole between said each bag and said next bag, said device comprising:
a shelf having a first end and an opposing second end, said second end carrying a bag stop formed to intercept said larger hole between said each bag and said next bag when said series of bags is drawn over said shelf from said first end to said second end, said bag stop preventing said next bag from following said each bag so that said each bag separates along said line of perforations from said next bag when said each bag has been drawn over said bag stop; and
means for attaching said shelf to said frame so that said first end is proximate to and underlaying said roll of bags and said second end is distal to said roll of bags by a distance sufficient to prevent said next bag from returning to said roll of bags when said each bag is separated by said bag stop, said attaching means holding said shelf so that said bag stop is oriented to intercept said much larger hole when said each bag is drawn over said shelf from said first end to said second end.

2. The apparatus as recited in claim 1, wherein said shelf has means for gripping said next bag as said bag stop intercepts said larger hole between said each bag and said next bag so that a balanced tension is applied to said line of perforations.

3. The apparatus as recited in claim 1, wherein said shelf has a pair of opposing notched edges positioned near said bag stop so that a balanced tension applied to said line of perforations as said bag stop intercepts said larger hole between said each bag and said next bag.

4. The apparatus as recited in claim 1, wherein said shelf tapers from wide at said first end to narrow at said second end.

5. The apparatus as recited in claim 1, wherein said bag stop is tapered from wide to narrow in a direction away from said second end.

6. The apparatus as recited in claim 1, wherein said shelf is made of a polycarbonate resin.

7. A device for use with a roll of bags in a generally horizontal position and freely rotatable about a generally horizontal axis, said roll of bags comprising a series of bags connected together, said each bag of said series of bags connected to a next bag in said series of bags and separable along a line of perforations including a much larger hole between said each bag and said next bag, said device comprising:
a frame;
a shelf having a first end and an opposing second end, said second end carrying a bag stop formed to intercept said larger hole between said each bag and said next bag when said series of bags is drawn over said shelf from said first end to said second end, said bag stop preventing said next bag from following said each bag so that said each bag separates along said line of perforations from said next bag when said each bag has been drawn over said bag stop; and
means for attaching said shelf to said frame so that said first end is proximate to and underlaying said roll of bags and said second end is distal to said roll of bags by a distance sufficient to prevent said next bag from returning to said roll of bags when said each bag is separated by said bag stop, said attaching means holding said shelf so that said bag stop is oriented to intercept said much larger hole when said each bag is drawn over said shelf from said first end to said second end.

8. The apparatus as recited in claim 7, wherein said shelf has means for gripping said next bag as said bag stop intercepts said larger hole between said each bag and said next bag so that a balanced tension is applied to said line of perforations.

9. The apparatus as recited in claim 7, wherein said shelf has a pair of opposing notched edges positioned near said bag stop so that a balanced tension applied to said line of perforations as said bag stop intercepts said larger hole between said each bag and said next bag.

10. The apparatus as recited in claim 7, wherein said shelf is tapered from wide at said first end to narrow at said second end.

11. The apparatus as recited in claim 7, wherein said bag stop is tapered from wide to narrow in a direction away from said second end.

12. The apparatus as recited in claim 7, wherein said shelf is made of a polycarbonate resin.

13. A device for use with a roll of bags in a generally horizontal position and freely rotatable about a generally horizontal axis, said roll of bags comprising a series of bags connected together, said each bag of said series of bags connected to a next bag in said series of bags and separable along a line of perforations including a much larger hole between said each bag and said next bag, said device comprising:
a frame;
a shelf having a first end and an opposing second end, said second end carrying a bag stop formed to intercept said larger hole between said each bag and said next bag when said series of bag is drawn over said shelf from said first end to said second end, said bag stop preventing said next bag from following said each bag so that said each bag separates along said line of perforations from said next bag when said each bag has been drawn over said bag stop, said shelf having means formed therein for catching said next bag so that said next bag is held to said shelf; and
means for attaching said shelf to said frame so that said first end is proximate to and underlaying said roll of bags and said second end is distal to said roll of bags so that said bag stop is oriented to intercept said much larger hole when said each bag is drawn over said shelf from said first end to said second end.

14. The apparatus as recited in claim 13, wherein said shelf has means for gripping said next bag as said bag stop intercepts said larger hole between said each bag and said next bag so that a balanced tension is applied to said line of perforations.

15. The apparatus as recited in claim 13, wherein said shelf has a pair of opposing notched edges positioned near said bag stop so that a balanced tension applied to said line of perforations as said bag stop intercepts said larger hole between said each bag and said next bag.

16. The apparatus as recited in claim 13, wherein said shelf is tapered from wide at said first end to narrow at said second end.

17. The apparatus as recited in claim 13, wherein said bag stop is tapered from wide to narrow in a direction away from said second end.

18. The apparatus as recited in claim 13, wherein said shelf is made of a polycarbonate resin.
